(19) United States
(12) Patent Application Publication
(10) Pub. No.: US 2003/0111499 A1
(43) Pub. Date: Jun. 19, 2003

(54) Fully assembled storage bin for extended cab pickup truck

(76) Inventors: Arnold Eugene French, Houston, TX (US); Betty Sue Hartenstine, Spring, TX (US)

Correspondence Address: Arnold E. French, 12211 Cedar Gap, Houston, TX, 77072, US

(21) Appl. No.: 10/017,648

(22) Filed: Dec. 18, 2001

(51) Int. Cl. B60R 7/00; B60R 9/00; B60R 11/00

(52) U.S. Cl. 224/275; 224/543

(57) ABSTRACT

A pre-assembled rectangular bin that fits on top of the back section of the back seat of an extended cab pickup truck. The bin consists of a rectangular body formed with a front panel, two end panels, a bottom panel and a back panel. The back panel is longer than the front panel, creating an extended portion. The extended portion of the bin fits behind the back seat of an extended cab pickup and supports the actual bin which is thereby positioned on top of the back seat in a manner that allows full access to the storage area of the bin.

Installation involves slipping the extended portion of the bin over the back seat. To remove the bin, pick it up and take it out of the truck.

Two divider panels are provided and can be slipped into place in the tracks inside the bin thereby providing the option of one, two or three separated storage spaces within the bins interior.

### BACKGROUND—DESCRIPTION OF PRIOR ART

The service industry was quick to see the advantages of an extended cab pickup for use in their business. It provides the convenient accessibility of items from the bed of the truck while adding an enclosed, lockable space in the area of the back seat. This additional space is an ideal area for service personnel to store valuable equipment and fragile items commonly necessary to be included in the inventory of a functional service vehicle. However, when this additional interior space is utilized to maximum capacity, it becomes a time consuming task to locate specific items and fragile items can be broken when left to shift around in the back seat.

Thereafter, inventors have created several types of storage containers specifically designed for extended cab pickup trucks. U.S. Pat. No. 5,709,329 to Johnson (1998) discloses a storage tray that is secured to the interior of the truck by notches and a support leg that extends to the floor of the pickup, however, this storage tray must be constructed and affixed to the interior of the truck and obstructs easy access to the remainder of the space. Furthermore, to remove this invention when the occasional need arises to accommodate larger items, service personnel must reverse the installation procedures. Later, to place the tray back into service, re-installation is required. U.S. Pat. No. 5,829,655 to Salopek (1998) shows a storage container that fits over the folded down jump seats of an extended cab pickup and can only be utilized on truck models that are built with these fold down jump seats. The majority of newer model pickups have a back seat that is permanently in place thereby ruling out the use of Salopek's invention.

Thus if the back seats are not foldable, utilization of all the space available is needed, or an easy in and easy out is desirable, neither of these inventions would be useful. OBJECTS AND ADVANTAGES

Accordingly several objects and advantages of my invention are:

(a) to provide a space for storage that is completely pre-assembled and is installed by simply placing the extended back of the bin behind the back of the back seat of an extended cab pickup truck;

(b) to provide a bin for storage that can be removed without any un-installation by picking up the bin and removing it;

(c) to provide a bin for storage that does not encumber the existing space provided by the manufacturer of the pickup;

(d) to provide a bin for storage that has divider sections that are optional and can be utilized by inserting the flat, square divider into the preset slots of the bin;

(e) to provide a bin for storage that is constructed of clear acrylic which allows visual inspection from the outside of the bin, without having to take out layers of contents to determine the location of the desired item;

(f) to provide a bin for storage that is constructed in more than one transparent color of acrylic;

### DRAWING FIGURES

FIG. 1 shows a perspective view of the present invention

FIG. 2 shows a cutaway side view of the back seat of an extended cab pickup truck in relation to the interior hull of the cab of said pickup truck and a side view of the present invention in place.

### REFERENCE NUMERALS IN DRAWINGS

10 back panel

20 end panel

30 front panel

40 bottom panel

42 divider insert

44 slots for receiving divider inserts

50 back section of back seat of extended cab pickup truck

60 space created by manufacturer of extended cab pickup truck

70 interior metal hull of cab of extended cab pickup truck

72 back window of cab of extended cab pickup truck

74 present invention in place SUMMARY

It is the primary objective of the present invention to provide a pre-assembled rectangular storage bin that can be quickly and easily placed into use and quickly and easily removed from use thereby allowing simple options in utilization of the space in the back seat of an extended cab pickup truck.

Accordingly, when the need arises to have items stored inside the cab of an extended cab pickup truck, the present invention would be utilized by placing the extended panel portion of the present invention over the back of the back seat, thereby positioning the rectangular storage bin portion of the present invention to be perched on top of the back of the back seat, providing a useable and accessible storage bin.

By reversing the procedure, that is, picking up the rectangular storage bin with the extended panel section and removing the present invention from service, the option for passenger seating is restored.

Summary Continued:

The storage area provided by the present invention would be located at the top of the back section of the back seat in an extended cab pickup truck.

In accordance with the present invention a storage bin comprises a front panel, back panel, two end panels, a bottom panel, 4 slots and 2 divider inserts.

### BRIEF DESCRIPTION OF THE DRAWINGS

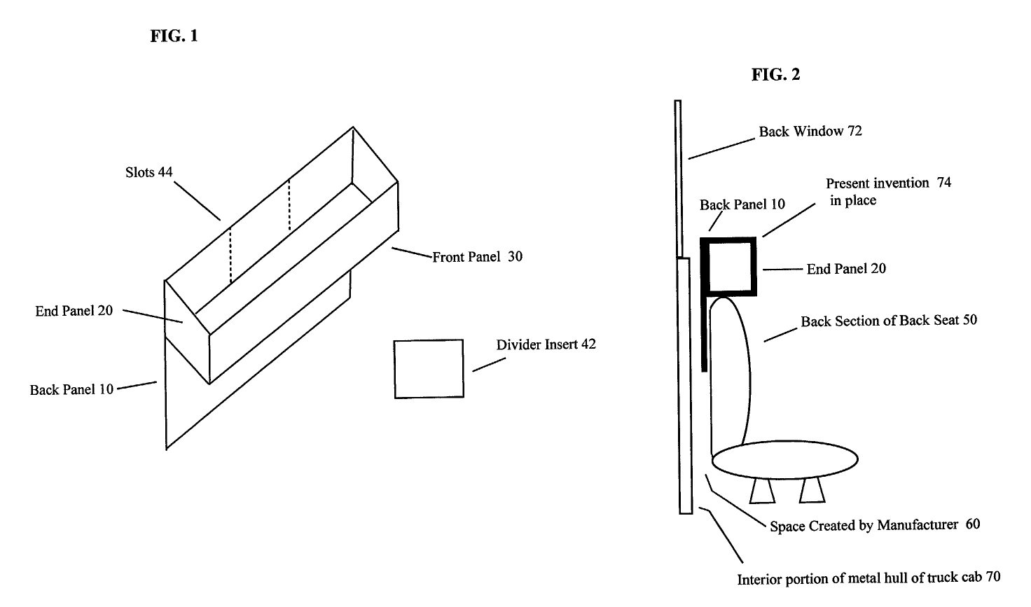

FIG. 1 is a perspective overall view of the present invention.

FIG. 2 is a cutaway view of the back seat of an extended cab pickup truck in relation to the interior portion of the metal hull of the cab showing the space to be utilized for placement of the present invention and a side view of the present invention in place.

### DESCRIPTION OF THE PREFERRED EMBODIMENT

Referring now to the drawings, more specifically to FIG. 1, the Fully Assembled Storage Bin For Extended Cab Pickup Trucks. The panels, back 10, end 20, front 30, divider 42 and bottom 40 are of ¼″ transparent acrylic plastic. The seams necessary to form the rectangular bin from panels have been bonded by a chemical weld. The chemical weld was created by applying a chemical, such as methelene chloride, to the two edges of the panels to be joined, creating the seam by melting each piece into the other until they are molded together with the strength of one solid piece.

### DESCRIPTION OF THE PREFERRED EMBODIMENT, CONTINUED:

The back panel 10 being longer than the front 30 and end 20 panels, extends downward past the bottom 40 of the bin thus creating the extended panel portion.

Referring now to FIG. 2, the space 60 that is created by the manufacturer of the extended cab pickup truck allows the extension of the back panel 10 of the present invention to be placed behind the back of the back seat 50 in an extended cab pickup truck. The relationship and orientation is shown of the present invention to the back portion of the back seat 50 of the extended cab pickup truck into the space 60 between the back of the back seat 50 and the interior portion of the metal hull 70 of the cab of the extended cab pickup truck.

The present invention has been described in considerable detail with reference to certain preferred embodiments thereof, but it will be understood that variations and modifications can be effected within the spirit and scope of the present invention.

### SUMMARY, RAMIFICATIONS AND SCOPE

The purpose of this invention is to provide easily accessible storage for small, valuable or fragile parts that are routinely carried by service persons. The space that the bin requires is minimal, and at the top of the back seat, leaving the seats themselves, and the floor, totally unencumbered. Therefore, none of the existing space is lost.

### REFERENCES CITED

| | | | |
|---|---|---|---|
| 5709329 | JANUARY, 1998 | JOHNSON | 224/402 |
| 5829655 | NOVEMBER 1998 | SALOPEK | 224/402 |

What is claimed is:

1. A fully assembled storage bin for use in an extended cab pick-up truck comprising:
a rectangular storage bin having a left and right end and further having a front and back panel;
the back panel extending downward past the bottom of the rectangular storage bin creating a means to support the bin atop the back section of the back seat of an extended cab pickup truck when said back panel extension is placed into the space between the back of the back seat and the interior metal hull of the cab;

2. A filly assembled storage bin as in claim 1 wherein said bin further comprises:
a transparent acrylic material for manufacture of said bin to provide a means to visibly assess the contents.

3. A fully assembled storage bin as in claim 1 wherein said bin further comprises:
a means for sectioning the storage area inside the said bin by inserting divider panels into slots provided inside the said bin.
